(19) United States
(12) Patent Application Publication
(10) Pub. No.: US 2023/0385770 A1
(43) Pub. Date: Nov. 30, 2023

(54) PROJECT MANAGEMENT DEVICE, PROJECT MANAGEMENT METHOD, AND RECORDING MEDIUM

(71) Applicant: JGC CORPORATION, Kanagawa (JP)

(72) Inventors: Hisayasu KAJI, Kanagawa (JP); Tomoaki ATSUMI, Kanagawa (JP); Taiga TAKASU, Kanagawa (JP); Aran SESHITA, Kanagawa (JP); Wataru MAKINO, Kanagawa (JP); Hiroki TAKAHASHI, Kanagawa (JP); Shinji ISHIDA, Tokyo (JP); Kuniharu NISHIHARA, Tokyo (JP); Midori SHIMIZU, Tokyo (JP)

(73) Assignee: JGC CORPORATION, Kanagawa (JP)

(21) Appl. No.: 18/032,559

(22) PCT Filed: Oct. 28, 2020
(86) PCT No.: PCT/JP2020/040494

§ 371 Date: Apr. 18, 2023

(51) Int. Cl. G06Q 10/10; G06Q 50/08; G06T 11/60

(52) U.S. Cl. CPC G06Q 10/103; G06Q 50/08; G06T 11/60; G06T 2200/24

(57) ABSTRACT

Provided is a project management apparatus including: a first acquisition unit configured to acquire an on-site image obtained by photographing a construction site in which an installation object is to be constructed; a second acquisition unit configured to acquire engineering model data on each of a plurality of components forming the installation object; a display control unit configured to display, on a display apparatus, a composite image obtained by superimposing the engineering model data on the on-site image; and a reception unit configured to receive an operation of a user, wherein the display control unit is configured to display, based on the operation performed on the composite image by the user, a display screen for causing the user to input information relating to progress of a work unit containing a work of a component corresponding to the engineering model data selected by the user, on the display apparatus.

### TECHNICAL FIELD

This disclosure relates to a project management apparatus, a project management method, and a recording medium.

### BACKGROUND ART

Hitherto, there has been known a system for supporting installation by displaying an image of a construction site while superimposing a virtual model thereon (see, for example, Patent Literature 1).

### CITATION LIST

### Patent Literature

[PTL 1] JP 2000-155855 A

### SUMMARY OF INVENTION

### Technical Problem

In order to properly manage a construction project, a progress status is required to be accurately updated without delay. However, inputting information relating to progress requires labor, and hence there is a fear in that progress may fail to be properly updated.

This disclosure describes a project management apparatus, a project management method, and a recording medium which are capable of reducing labor required for inputting information relating to progress.

### Solution to Problem

A project management apparatus according to one aspect of this disclosure is an apparatus for managing a project of constructing an installation object. The project management apparatus includes: a first acquisition unit configured to acquire an on-site image obtained by photographing a construction site in which the installation object is to be constructed; a second acquisition unit configured to acquire engineering model data on each of a plurality of components forming the installation object; a display control unit configured to display, on a display apparatus, a composite image obtained by superimposing the engineering model data on the on-site image; and a reception unit configured to receive an operation of a user. The display control unit is configured to display, based on the operation performed on the composite image by the user, a display screen for causing the user to input information relating to progress of a first work unit, which is a work unit containing a work of a first component being a component corresponding to the engineering model data selected by the user, on the display apparatus.

A project management method according to another aspect of this disclosure is a method of managing a project of constructing an installation object. The project management method includes: acquiring an on-site image obtained by photographing a construction site in which the installation object is to be constructed; acquiring engineering model data on each of a plurality of components forming the installation object; generating a composite image by superimposing the engineering model data on the on-site image and displaying the composite image on a display apparatus; and displaying, based on an operation performed on the composite image by a user, a display screen for causing the user to input information relating to progress of a first work unit, which is a work unit containing a work of a first component being a component corresponding to the engineering model data selected by the user, on the display apparatus.

A recording medium according to still another aspect of this disclosure is a computer-readable recording medium having recoded thereon a project management program for causing a computer to operate to manage a project of constructing an installation object. The project management program is a program for causing the computer to execute: acquiring an on-site image obtained by photographing a construction site in which the installation object is to be constructed; acquiring engineering model data on each of a plurality of components forming the installation object; generating a composite image by superimposing the engineering model data on the on-site image and displaying the composite image on a display apparatus; and displaying, based on an operation performed on the composite image by a user, a display screen for causing the user to input information relating to progress of a first work unit, which is a work unit containing a work of a first component being a component corresponding to the engineering model data selected by the user, on the display apparatus.

In the project management apparatus, the project management method, and the recording medium that are described above, the composite image generated by superimposing the engineering model data on the on-site image is displayed on the display apparatus. With this configuration, the user can visually grasp a progress status of the first work unit from the composite image. Then, when the user selects the engineering model data in the composite image, the display screen for causing the user to input the information relating to the progress of the first work unit including the work of the first component corresponding to the engineering model data selected by the user is displayed on the display apparatus. Therefore, it is possible to prompt the user to input the information relating to the progress of the first work unit. After visually grasping the progress status of the first work unit, the user can input the information relating to the progress of the first work unit without delay. As a result, it is possible to reduce labor required for inputting information relating to progress.

The above-mentioned project management apparatus may further include a calculation unit configured to calculate a work volume of the work unit. The display control unit may be configured to display the work volume on the display apparatus based on the operation performed on the composite image by the user. With this configuration, the user can grasp the work volume of the work unit.

The display screen may include a region that enables the user to input a schedule of the first work unit. The calculation unit may be configured to calculate the work volume based on the schedule input by the user. When the schedule of a work unit is changed, the work volume of the work unit can change. For example, when a planned finish date of the first work unit is changed to a date earlier than a date serving as a reference date, all the works of the first work unit are supposed to have been finished. With the above-mentioned configuration, when the schedule of the first work unit is input, the work volume of the first work unit can be properly updated. Therefore, the user can accurately grasp the work volume of the first work unit.

The display screen may include a region that enables the user to input a progress state of the first component. The calculation unit may be configured to calculate the work volume based on the progress state input by the user. When the progress state of a component is changed, the work volume of the work unit containing this component can change. For example, when the progress state of the first component is changed from “not installed” to “installed,” the work volume of the first component is added to the work volume of the first work unit. With the above-mentioned configuration, when the progress state of the first component is input, the work volume of the first work unit can be properly updated. Therefore, the user can accurately grasp the work volume of the first work unit.

The display control unit may be configured to display engineering drawing data containing the first component on the display apparatus based on the operation performed on the composite image by the user. In this case, the user can examine an engineering drawing on the display apparatus. For example, a worker at a construction site is not required to bring an engineering drawing document to the construction site, and hence it is possible to reduce a load on the worker.

The display control unit may be configured to display procurement information on the first component on the display apparatus based on the operation performed on the composite image by the user. In this case, the user can examine procurement information on the display apparatus. For example, the worker at the construction site is not required to bring a document relating to the procurement information to the construction site, and hence it is possible to reduce a load on the worker.

### Advantageous Effects of Invention

According to each aspect and each embodiment of this disclosure, it is possible to reduce the labor required for inputting the information relating to progress.

### BRIEF DESCRIPTION OF DRAWINGS

FIG. 1 is a configuration diagram for schematically illustrating a project management system including a project management apparatus according to an embodiment of this disclosure.

FIG. 2 is a hardware configuration diagram for illustrating the project management apparatus illustrated in FIG. 1.

FIG. 3 is a view for illustrating an example of an outer appearance of the project management apparatus illustrated in FIG. 1.

FIG. 4 is a table for showing a configuration example of a work package information DB illustrated in FIG. 1.

FIG. 5 is a table for showing a configuration example of a component information DB illustrated in FIG. 1.

FIG. 6 is a flowchart for illustrating a series of procedures of a project management method to be executed by the project management apparatus illustrated in FIG. 1.

FIG. 7 is a diagram for illustrating an example of a composite image.

FIG. 8 is a diagram for illustrating an example of a display screen for displaying information relating to a component.

FIG. 9 is a diagram for illustrating an example of a display screen displayed when an icon for displaying information relating to construction of the component is selected.

FIG. 10 is a diagram for illustrating an example of a display screen for displaying property information on the component.

FIG. 11 is a diagram for illustrating an example of a display screen for examining detailed information relating to an IWP.

FIG. 12 is a diagram for illustrating an example of a display screen for examining detailed information relating to a CWP2.

FIG. 13 is a diagram for illustrating an example of a display screen for examining detailed information relating to a CWP1.

FIG. 14 is a diagram for illustrating an example of a display screen for causing a user to input a progress state of a construction work of the component.

FIG. 15 is a diagram for illustrating an example of a display screen for displaying visualization information relating to a project.

FIG. 16 is a diagram for illustrating an example of a display screen for setting a granularity of the visualization information.

FIG. 17 is a diagram for illustrating an example of a display screen on which a schedule of each CWP1 is visualized.

FIG. 18 is a diagram for illustrating an example of a display screen on which a progress rate of each CWP1 is visualized.

FIG. 19 is a diagram for illustrating an example of a display screen for examining arrangement of construction equipment.

FIG. 20 is a diagram for illustrating a configuration of a project management program recorded in a recording medium.

### DESCRIPTION OF EMBODIMENTS

A detailed description is now given of an embodiment of this disclosure with reference to the accompanying drawings. In the description of the drawings, the same components are denoted by the same reference symbols, and a redundant description thereof is omitted.

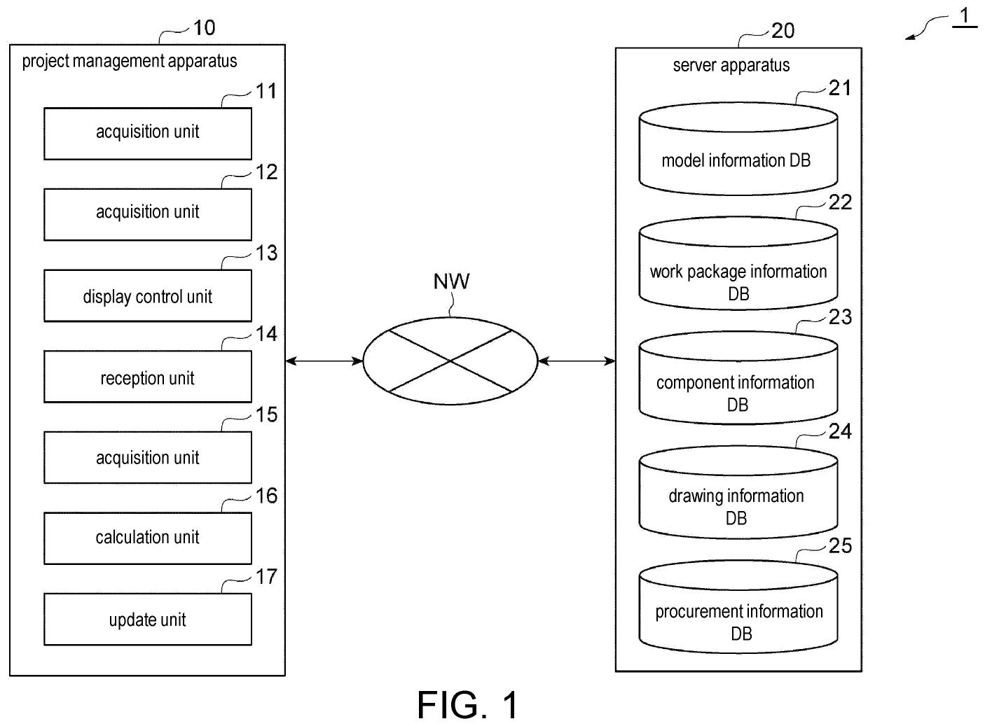

FIG. 1 is a configuration diagram for schematically illustrating a project management system including a project management apparatus according to the embodiment. The project management system 1 illustrated in FIG. 1 is a system for managing a project of building (constructing) an installation object. Examples of the installation object include a plant in a field of oil/gas and a plant in a field of infrastructure. Examples of the plant in the oil/gas field include a petroleum refinery plant, a gas treatment plant, a natural gas liquefying plant, a petrochemical plant, and a chemical product manufacturing plant. Examples of the plant in the infrastructure field include a thermal power generation plant, an atomic power generation plant, and a renewable energy power generation plant. The project may include three phases, which are engineering, procurement, and construction.

The project management system 1 uses, for example, Advanced Work Packaging (AWP) to manage a project. The AWP is a method of managing a project through use of work packages. The work package is a work unit for building the installation object. Details of a work, a man-hour, a cost, resources, a schedule, and the like are assigned to the work package. Examples of the work package include an engineering work package (EWP), a procurement work package (PWP), a construction work package (CWP), and an installation work package (IWP). The EWP is a work unit of the engineering. The PWP is a work unit of the procurement. The CWP is a work unit of the construction. The IWP is obtained by subdividing the CWP. The IWP is a work unit for a work supervisor to manage a site work, and is a work that can be completed in, for example, four weeks or less.

In this embodiment, a CWP is subdivided into CWP1s and CWP2s. CWP2s are intended for areas obtained by dividing subject areas of CWP1s. An IWP is a work unit obtained by further subdividing the CWP2.

The project management system 1 includes one or a plurality of project management apparatus 10 and a server apparatus 20. In the description given below, a configuration in which the project management system 1 includes one project management apparatus 10 is exemplified. The project management apparatus 10 and the server apparatus 20 are connected to each other for communication through a network NW. The network NW may be any one of a wired network and a wireless network. Examples of the network NW include the Internet, a mobile communication network, and a wide area network (WAN).

The project management apparatus 10 is an apparatus for managing a project for building (constructing) an installation object. The project management apparatus 10 is used by a user, and executes various types of procedures based on an operation of the user. When the project management apparatus 10 is used at a construction site, a portable terminal apparatus such as a tablet terminal, a smartphone, or a notebook personal computer (PC) is used as the project management apparatus 10. When the project management apparatus 10 is used in a place other than a construction site, a terminal apparatus such as a desktop PC, a notebook PC, a tablet terminal, or a smartphone is used as the project management apparatus 10.

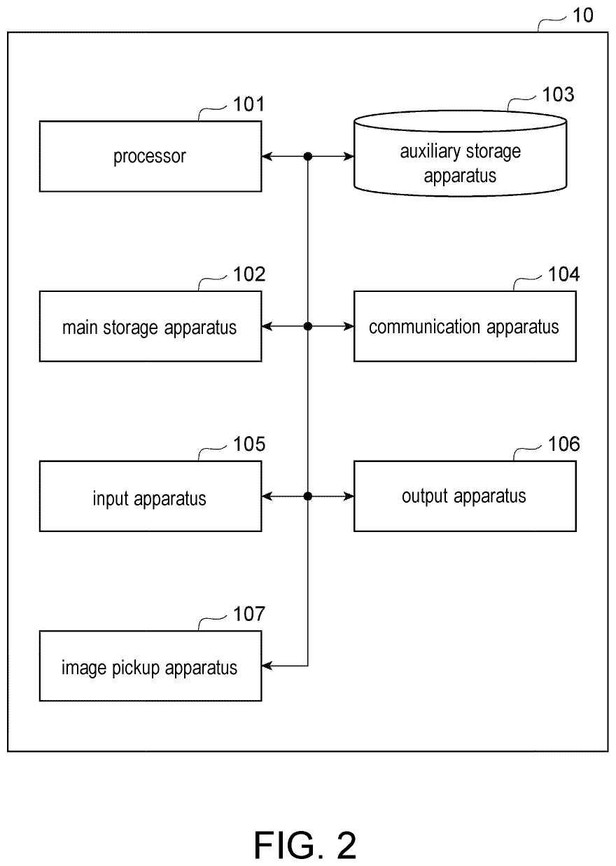

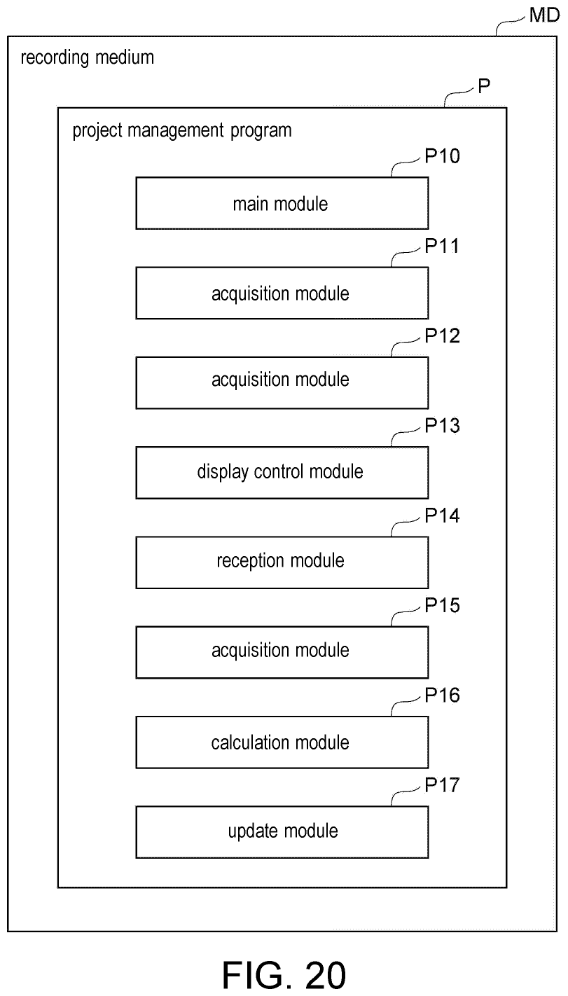

FIG. 2 is a hardware configuration diagram for illustrating the project management apparatus illustrated in FIG. 1. As illustrated in FIG. 2, the project management apparatus 10 may be physically constructed as a computer including hardware components such as one or a plurality of processors 101, a main storage apparatus 102, an auxiliary storage apparatus 103, a communication apparatus 104, an input apparatus 105, an output apparatus 106, and an image pickup apparatus 107. Examples of the processor 101 include a central processing unit (CPU). The main storage apparatus 102 is constructed by a random access memory (RAM), a read only memory (ROM), and the like. Examples of the auxiliary storage apparatus 103 include a semiconductor memory and a hard disk drive. The auxiliary storage apparatus 103 stores a project management program P (see FIG. 20).

The communication apparatus 104 is an apparatus for transmitting and receiving data to and from other apparatus through the network NW. The communication apparatus 104 is constructed by, for example, a network interface card (NIC) or a wireless communication module. Encryption may be used for the transmission/reception of data through the network NW. The input apparatus 105 is an apparatus to be used when the user operates the project management apparatus 10. The input apparatus 105 is constructed by, for example, a touch panel, a keyboard, and a mouse. The output apparatus 106 is an apparatus for outputting various types of information. The output apparatus 106 is constructed by, for example, a display and a speaker.

The image pickup apparatus 107 is an apparatus for picking up an image (imaging). The image pickup apparatus 107 is, for example, a camera module. Specifically, the image pickup apparatus 107 includes a plurality of optical system components such as a lens and an image pickup element, a plurality of control system circuits for driving and controlling those components, and a signal processing system circuit unit for converting an electrical signal representing a picked-up image generated by the image pickup element into an image signal being a digital signal.

The processor 101 reads the project management program P stored in the auxiliary storage apparatus 103 onto the main storage apparatus 102, and executes the project management program P so that the respective pieces of hardware operate under the control of the processor 101, and data is read from and written to the main storage apparatus 102 and the auxiliary storage apparatus 103. As a result, respective function units of the project management apparatus 10 illustrated in FIG. 1 are implemented.

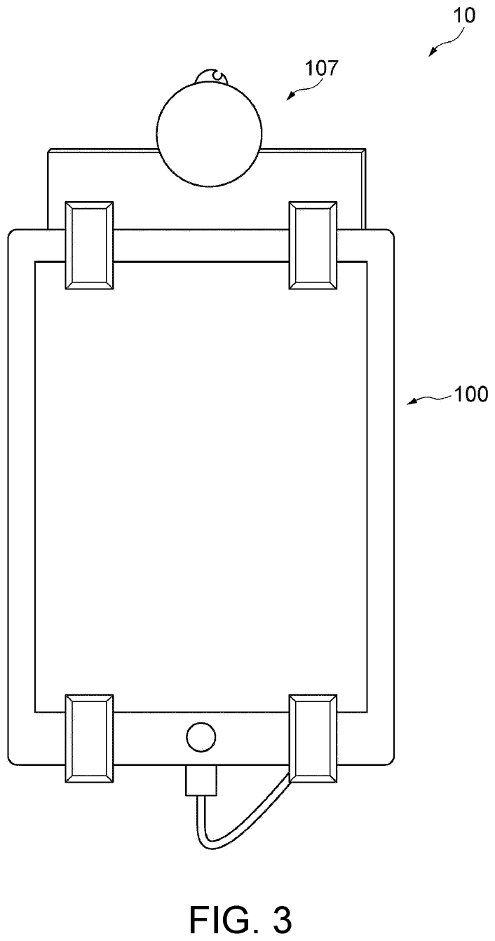

FIG. 3 is a view for illustrating an example of an outer appearance of the project management apparatus illustrated in FIG. 1. As illustrated in FIG. 3, the project management apparatus 10 has a configuration in which the image pickup apparatus 107 (camera module) is attached to, for example, an upper end of a tablet terminal 100. The camera module is configured such that a direction of photographing can be freely changed.

The server apparatus 20 is an apparatus that functions as a database which stores various types of information. The server apparatus 20 has the same hardware configuration as that of the project management apparatus 10. The server apparatus 20 is not required to include the input apparatus 105 and the output apparatus 106. As illustrated in FIG. 1, the server apparatus 20 functionally includes a model information DB 21, a work package information DB 22, a component information DB 23, a drawing information DB 24, and a procurement information DB 25.

The model information DB 21 stores engineering model information and construction equipment model information. The engineering model information is set in advance for each component. Each piece of engineering model information contains a component identifier (ID), engineering model data, an area ID, and position information.

The component ID is information that enables a component to be uniquely identified. The component is an element forming the installation object. Examples of the component include a foundation, a steel structure, a piping, equipment, coating, a heat insulating material, an electrical component, instrumentation, and an underground structure. The engineering model data is simulation model data on the component identified by the component ID. In this embodiment, a 3D model data is used as the engineering model data. The area ID is information that enables unique identification of an area to which the component identified by the component ID belongs. The area ID is sometimes referred to as “PCWBS.” The area in which the project is performed is divided into a plurality of areas. The position information is information indicating a position of the component identified by the component ID (location at which the component is arranged).

The construction equipment model information is set in advance for each piece of construction equipment used at a construction site. Examples of the construction equipment include a scaffolding and a crane. Each piece of construction equipment model information contains a construction equipment ID and construction equipment model data. The construction equipment ID is information that enables a piece of construction equipment to be uniquely identified. The construction equipment model data is simulation model data on the piece of construction equipment identified by the construction equipment ID. In this embodiment, 3D model data is used as the construction equipment model data.

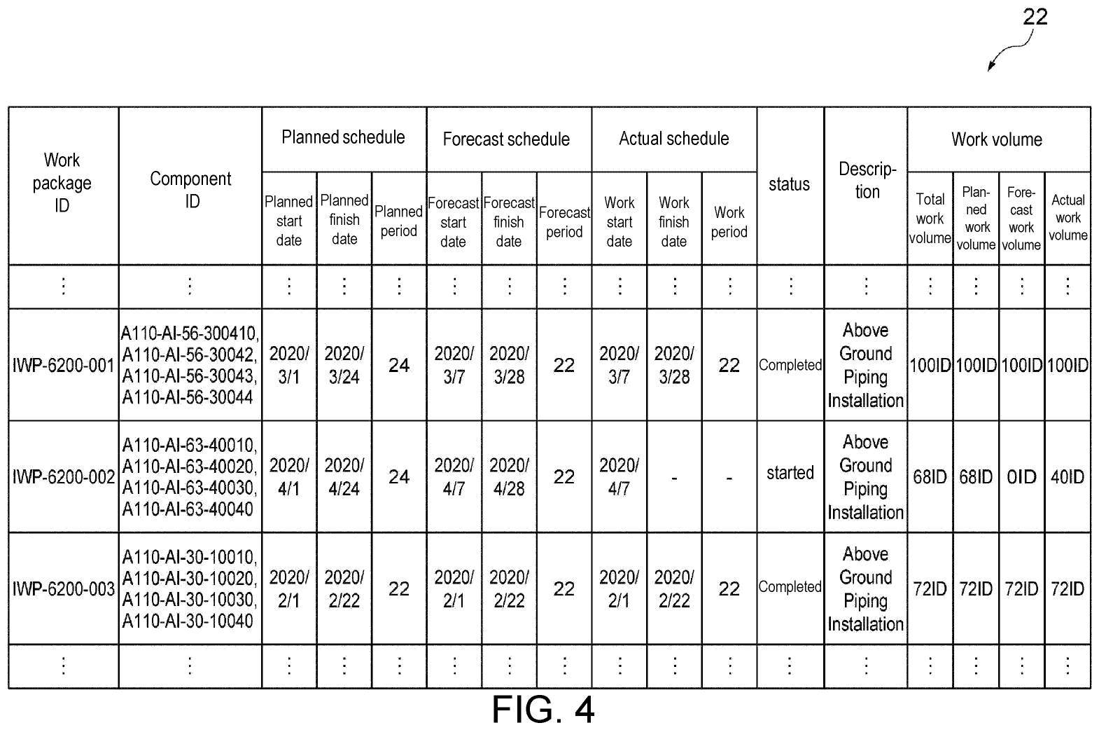

The work package information DB 22 stores work package information. The work package information is set for each work package. The work package information contains, for example, CWP1 information, CWP2 information, and IWP information. As shown in FIG. 4, each piece of work package information contains a work package ID, a component ID, planned schedule information, forecast schedule information, actual schedule information, status information, description information, and work volume information.

The work package ID is identification information that enables a work package to be uniquely identified. A work package ID starting from “CWP1-” indicates the CWP1. A work package ID starting from “CWP2-” indicates the CWP2. A work package ID starting from “IWP-” indicates the IWP. CWP1s and CWP2s are groups each constructed by areas and work types (functions). The work packages ID of CWP1s and CWP2s contain area IDs and work type codes indicating work types. The work type codes are sometimes referred to as “FWBS.” For example, a work package indicated by a work package ID of “CWP1-6000-A100” indicates a piping work indicated by a work type code of “6000” in an area indicated by an area ID of “A100.”

The component ID is information that enables a component to be uniquely identified. In this case, the component ID is identification information on a component registered in the work package identified by the work package ID.

The planned schedule information is information indicating a schedule (planned schedule) initially presented to a customer in a contract or the like. The planned schedule information contains a planned start date, a planned finish date, and a planned period. The planned start date is a date on which the work package identified by the work package ID is planned to be started. The planned finish date is a date on which the work package identified by the work package ID is planned to be finished. The planned period is the number of days required for the work package identified by the work package ID.

The forecast schedule information is information indicating a schedule presented to the customer when there is a change in the planned schedule. The forecast schedule information contains a forecast start date, a forecast finish date, and a forecast period. The forecast start date is a date on which the work package identified by the work package ID is forecast to be started. The forecast finish date is a date on which the work package identified by the work package ID is forecast to be finished. The forecast period is the number of days forecast to be required for the work package identified by the work package ID.

The actual schedule information contains a work start date, a work finish date, and a work period. The work start date is an actual date on which the work package identified by the work package ID is started. The work finish date is an actual date on which the work package identified by the work package ID is finished. The work period is an actual number of days required for the work package identified by the work package ID.

The status information is information indicating a progress state of the work package identified by the work package ID. Examples of the progress state include “not started,” “started,” and “completed.” The status information is set to information indicating “not started” when work package information is generated. The description information is information indicating details of a construction work (construction work outline description) of the work package identified by the work package ID.

The work volume information is information indicating a work volume of the work package identified by the work package ID. The work volume contains a total work volume, a planned work volume, a forecast work volume, and an actual work volume. The total work volume is a work volume of the entire work package. The planned work volume is a work volume initially presented to the customer in a contract or the like. The forecast work volume is a work volume presented to the customer when there is a change in the planned work volume. The actual work volume is a work volume actually performed.

The work package information shown in FIG. 4 is IWP information. The work package information DB 22 further stores the CWP1 information and the CWP2 information that are similar to the IWP information. The CWP1 information is different from the IWP information mainly in that the work package ID of the CWP2 that forms the CWP1 is contained instead of the component ID. The CWP2 information is different from the IWP information mainly in that the work package ID of the IWP that forms the CWP2 is contained instead of the component ID.

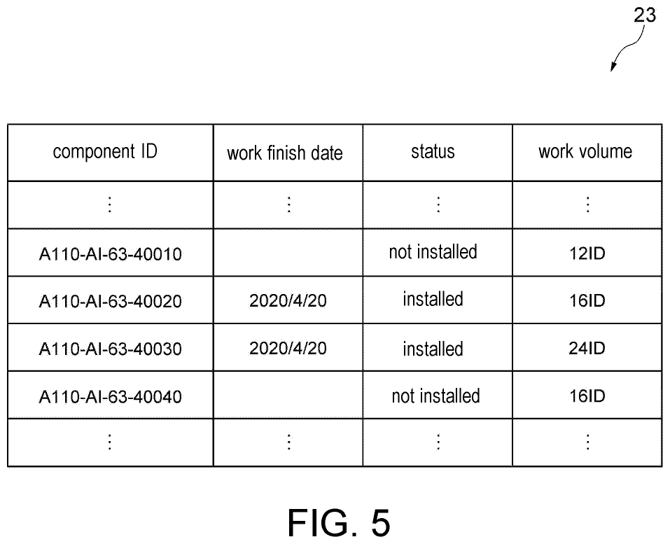

The component information DB 23 stores component information. The component information is set for each component. As shown in FIG. 5, each piece of component information contains a component ID, a work finish date, status information, and work volume information.

The work finish date is a date on which the work (construction work) of the component identified by the component ID is finished. The status information is information indicating the progress state of the work (construction work) of the component identified by the component ID. Examples of the progress state include “not installed” and “installed.” The status information is set to information indicating “not installed” when component information is generated.

The work volume information is information indicating a work volume of a component identified by the component ID. When the component is a piping, the work volume is, for example, a welding amount. As a unit of the welding amount, “inchdia (ID)” is used. The welding amount of “1 ID” means a welding amount in a case in which a piping having a diameter of one inch is welded along its entire circumference. When the component is a steel structure, the work volume is, for example, the weight of the steel structure. As a unit of the weight of the steel structure, “ton” is used. When the component is a foundation, the work volume is, for example, the volume of the foundation. As a unit of the volume of the foundation, “cubic meter (m 3)” is used. As described above, a unit corresponding to the type of the component is used.

The drawing information DB 24 stores drawing information. The drawing information is set for each component. Each piece of drawing information contains a component ID and engineering drawing data. The engineering drawing data is data indicating an engineering drawing including the component identified by the component ID. The engineering drawing data contains layout information, for example, dimensions, information relating to materials, information relating to supports, and information relating to spools. The engineering drawing data may be a portable document format (PDF) file, metadata, or the like. The drawing information may further contain information indicating an issue status of a drawing. Examples of the issue status include issue for approval (IFA) and issue for construction (IFC). A plurality of pieces of engineering drawing data may be associated with one component.

The procurement information DB 25 stores procurement information. The procurement information is set for each component. Each piece of procurement information contains a component ID, procurement specification data, purchase order data, and transportation information. The procurement specification data is data on a procurement specification of the component identified by the component ID. The purchase order data is data on a purchase order for the component identified by the component ID. The transportation information is information relating to transportation of the component identified by the component ID. The transportation information contains information indicating transportation statuses such as “in transport,” “arrived at port,” and “arrived at site,” and planned schedule information and actual schedule information for each transportation status.

The planned schedule information contains a planned start date, a planned completion date, and a planned period. For example, the planned start date of transportation is a date on which the transportation of the component identified by the component ID is planned to be started. The planned completion date of the transportation is the date on which the transportation of the component identified by the component ID is planned to be completed. The planned period of the transportation is the number of days to be required for the transportation of the component identified by the component ID.

The actual schedule information contains an actual result start date, an actual result completion date, and an actual result period. For example, the actual result start date of the transportation is an actual date on which the transportation of the component identified by the component ID is started. The actual result completion date of the transportation is an actual date on which the transportation of the component identified by the component ID is completed. The actual result period of the transportation is the actual number of days required for the transportation of the component identified by the component ID.

As illustrated in FIG. 1, the project management apparatus 10 functionally includes an acquisition unit 11 (first acquisition unit), an acquisition unit 12 (second acquisition unit), a display control unit 13, a reception unit 14, an acquisition unit 15, a calculation unit 16, and an update unit 17. A function (operation) of each function unit is described in detail when a project management method is described later, and hence the function of each function unit is briefly described below.

The acquisition unit 11 is a function unit that acquires an on-site image obtained by photographing a construction site. The on-site image may be a real-time video (moving image) or a still image. For example, the acquisition unit 11 acquires the on-site image obtained through photographing by the user of the project management apparatus 10 through use of the image pickup apparatus 107.

The acquisition unit 12 is a function unit that acquires the engineering model data on each of a plurality of components that form an installation object. For example, the acquisition unit 12 acquires engineering model data on a component to be installed in a region included in the on-site image.

The display control unit 13 is a function unit that displays various kinds of display content on a display apparatus (display). The display control unit 13 outputs display information for displaying predetermined display content to the display apparatus, and the display apparatus displays predetermined information based on the display information. The display control unit 13 displays a composite image obtained by superimposing the engineering model data on the on-site image on the display apparatus. The display control unit 13 changes the display content to be displayed on the display apparatus in accordance with an operation performed on the composite image by the user. For example, the display control unit 13 displays a display screen for causing the user to input information relating to the progress of a work package (first work unit) including the work of a component (first component) corresponding to the engineering model data selected by the user on the display apparatus based on the operation performed on the composite image by the user. Details of the display content are described later.

The reception unit 14 is a function unit that receives an operation of the user. The reception unit 14 generates operation information indicating details of the operation of the user.

The acquisition unit 15 is a function unit that acquires information corresponding to the operation of the user. The acquisition unit 15 acquires required information from each of the DBs of the server apparatus 20 in accordance with the operation of the user.

The calculation unit 16 is a function unit that calculates a work volume of the work package. The calculation unit 16 recalculates the work volume when an operation that can affect the work volume is performed by the user.

The update unit 17 is a function unit that updates various kinds of information stored in the server apparatus 20. When the information is changed by the user, the update unit 17 updates the information stored in the server apparatus 20 to the changed information.

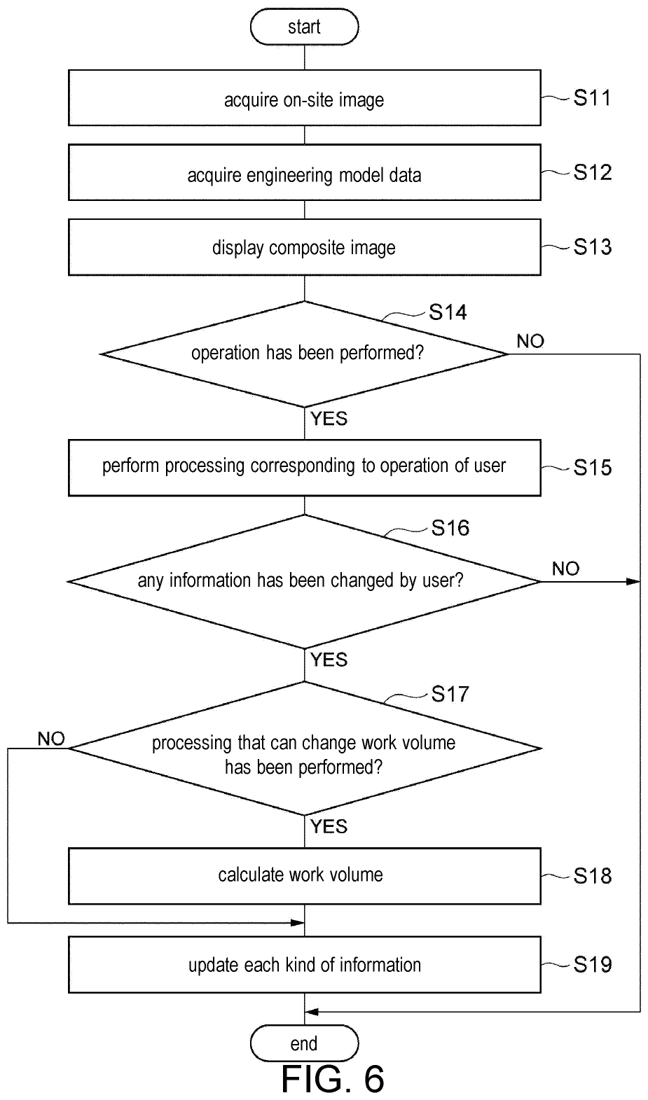

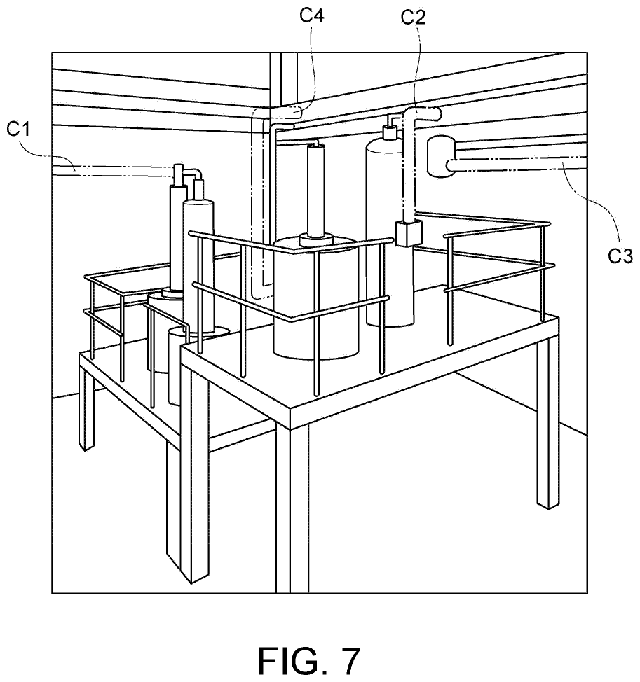

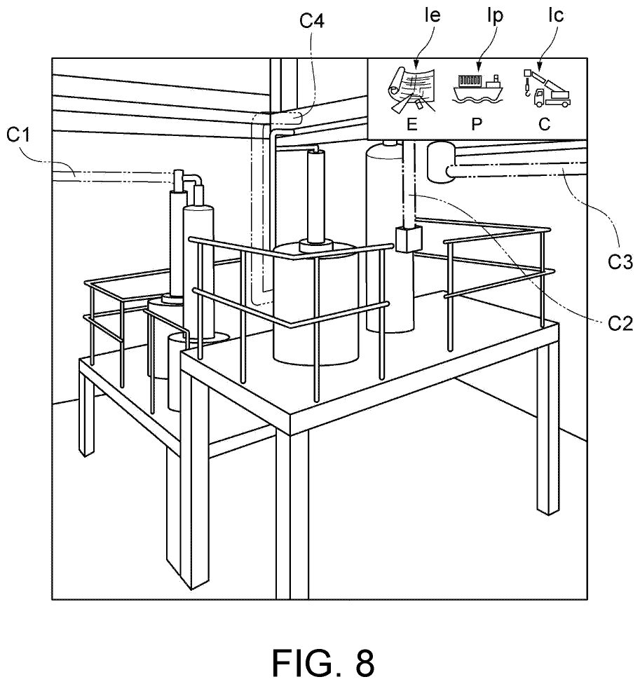

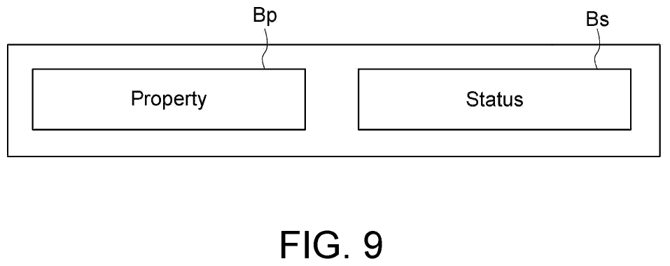

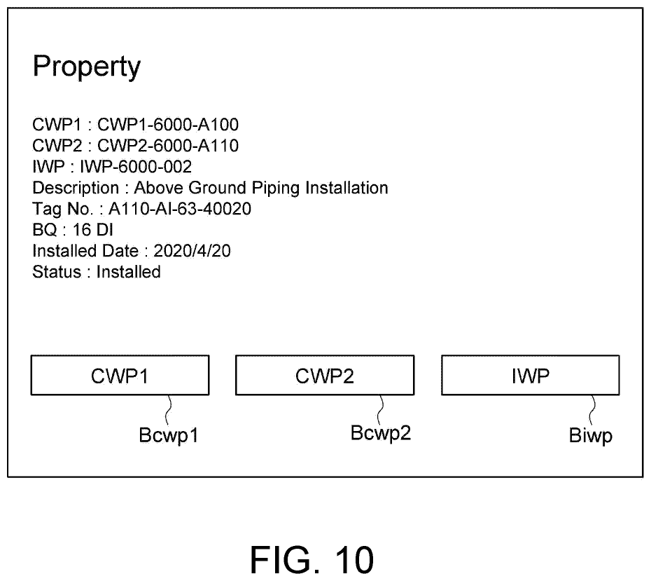

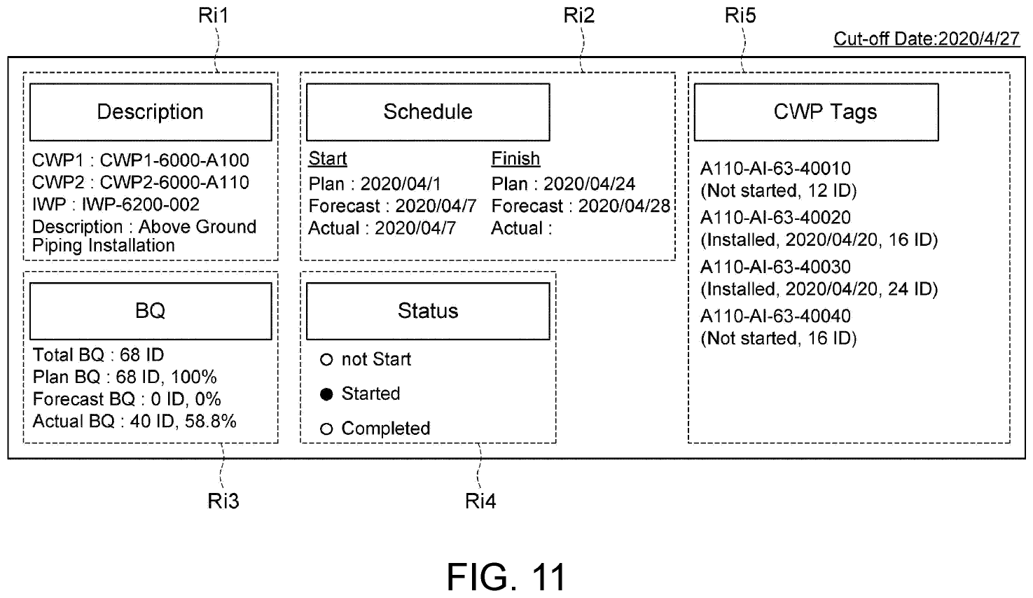

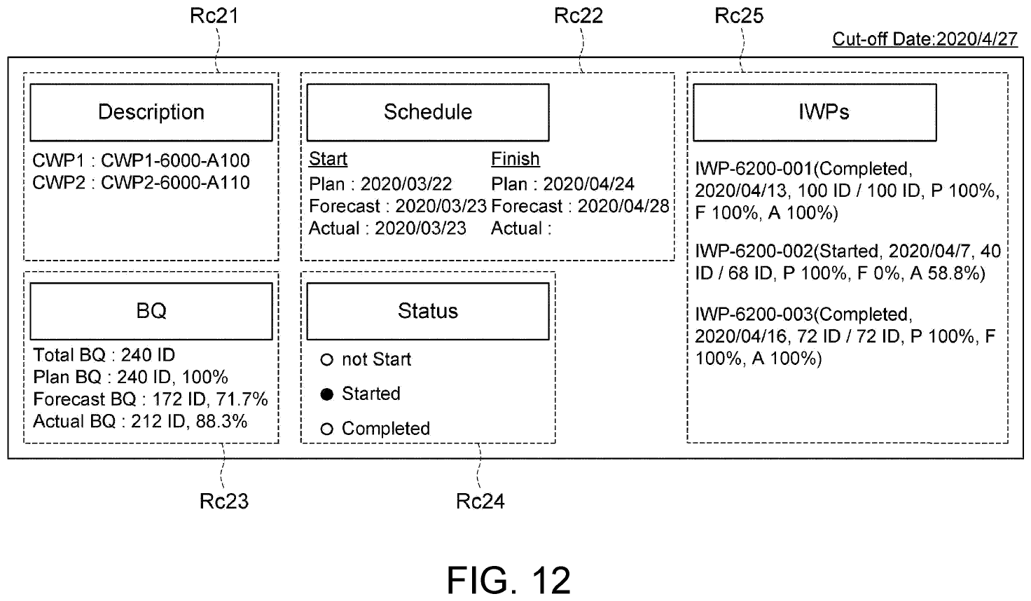

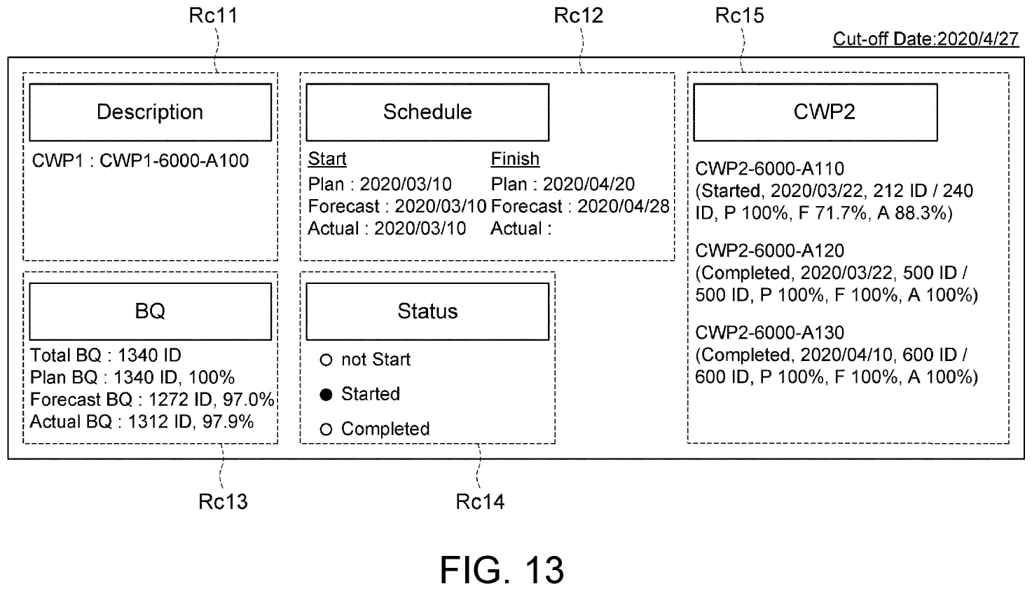

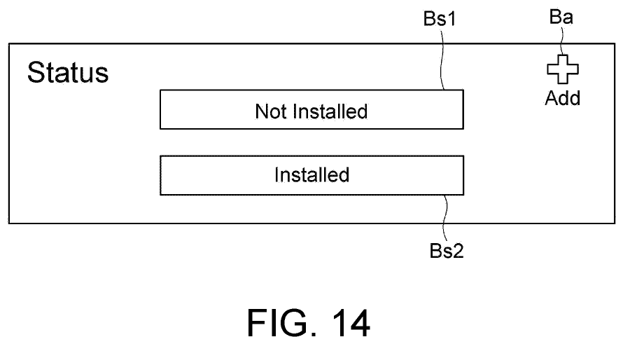

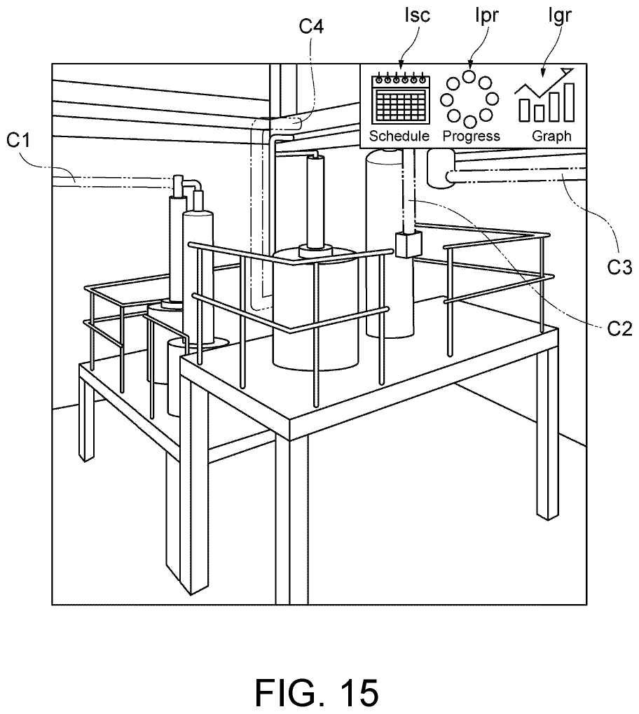

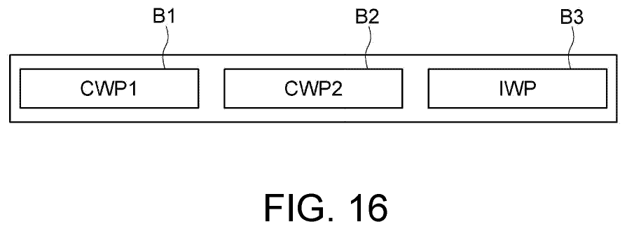

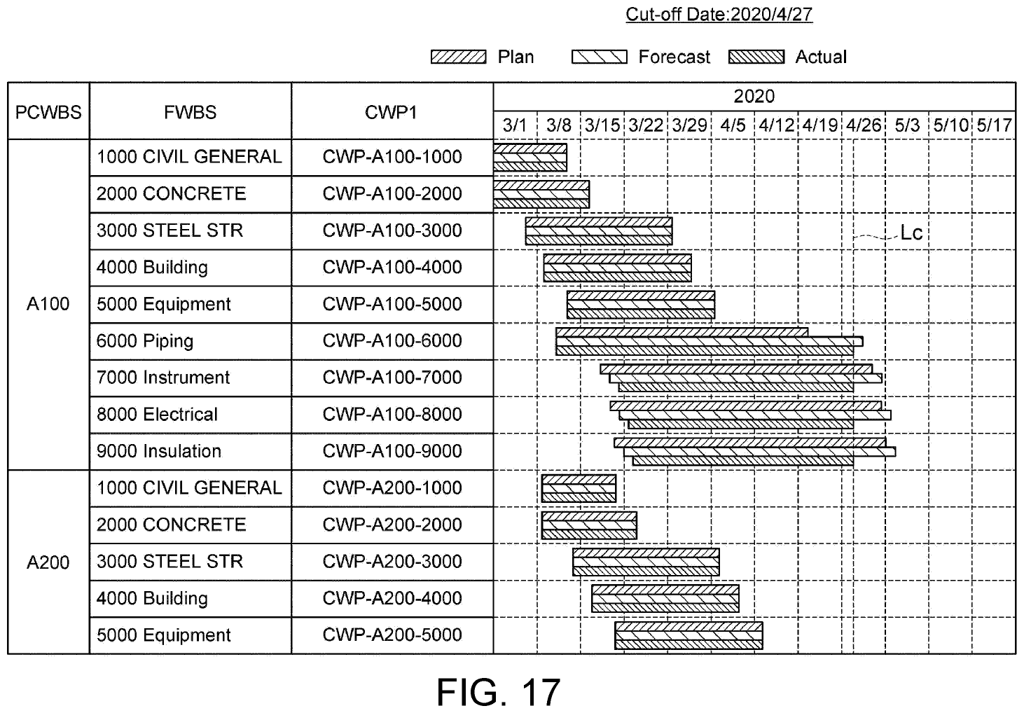

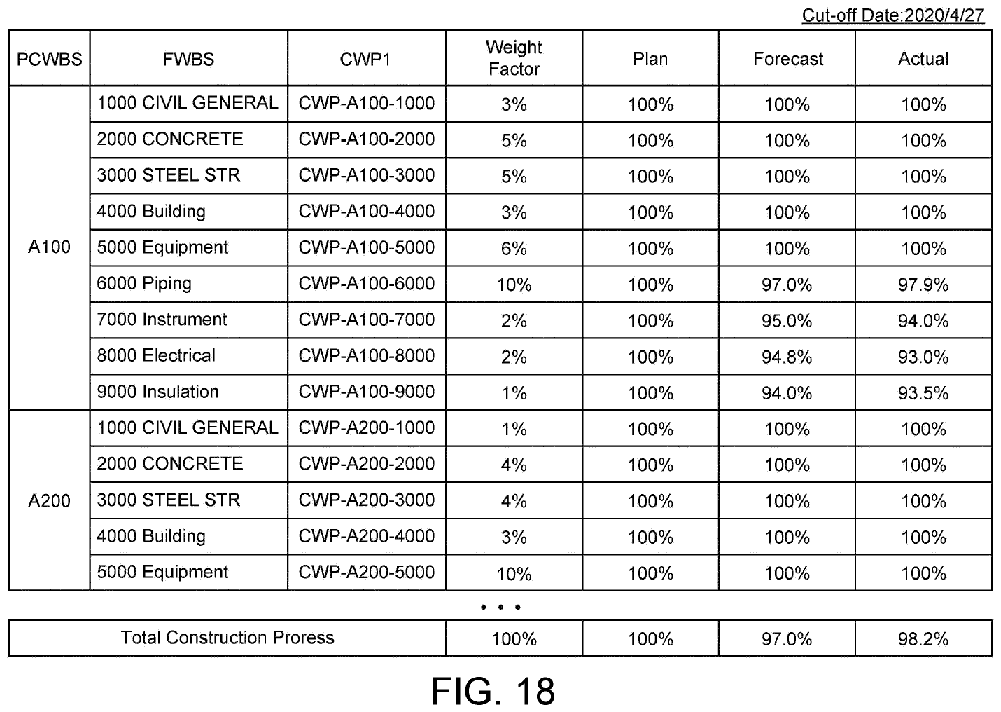

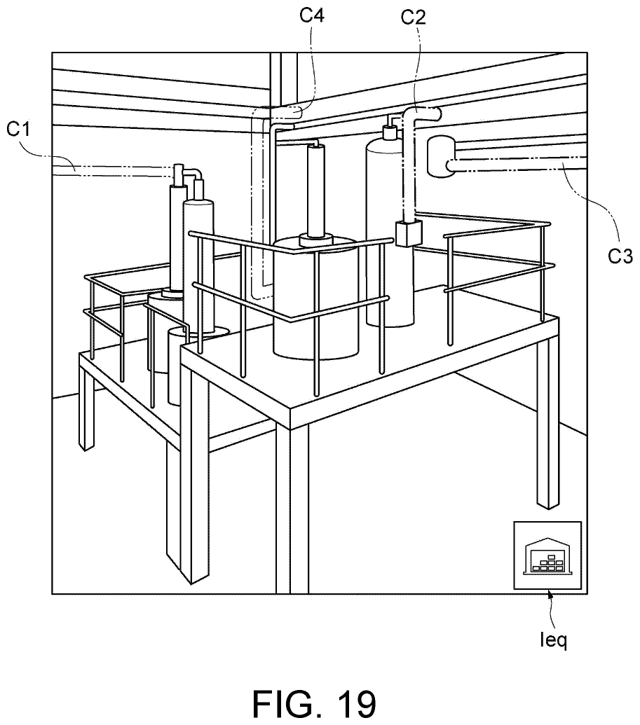

Next, the project management method to be executed by the project management apparatus 10 is described. FIG. 6 is a flowchart for illustrating a series of procedures of the project management method to be executed by the project management apparatus illustrated in FIG. 1. FIG. 7 is a diagram for illustrating an example of the composite image. FIG. 8 is a diagram for illustrating an example of a display screen for displaying information relating to a component. FIG. 9 is a diagram for illustrating an example of a display screen displayed when an icon for displaying information relating to construction of the component is selected. FIG. 10 is a diagram for illustrating an example of a display screen for displaying property information on the component. FIG. 11 is a diagram for illustrating an example of a display screen for examining detailed information relating to an IWP. FIG. 12 is a diagram for illustrating an example of a display screen for examining detailed information relating to a CWP2. FIG. 13 is a diagram for illustrating an example of a display screen for examining detailed information relating to a CWP1. FIG. 14 is a diagram for illustrating an example of a display screen for causing the user to input the progress state of a construction work of the component. FIG. 15 is a diagram for illustrating an example of a display screen for displaying visualization information relating to a project. FIG. 16 is a diagram for illustrating an example of a display screen for setting a granularity of the visualization information. FIG. 17 is a diagram for illustrating an example of a display screen on which a schedule of each CWP1 is visualized. FIG. 18 is a diagram for illustrating an example of a display screen on which a progress rate of each CWP1 is visualized. FIG. 19 is a diagram for illustrating an example of a display screen for examining arrangement of construction equipment.

The series of procedures illustrated in FIG. 6 is repeatedly started at regular time intervals after an application for operating a work package is activated on the project management apparatus 10. A case in which a worker at a construction site uses the project management apparatus 10 illustrated in FIG. 3 is described below as an example. Before the series of procedures illustrated in FIG. 6 is performed, the work volume is preliminarily calculated.

The preliminary calculation of the work volume is described. First, the acquisition unit 15 acquires IWP information stored in the work package information DB 22. Then, the acquisition unit 15 acquires component information on all components forming an IWP from the component information DB 23. Then, the calculation unit 16 computes a total sum of the work volumes of all pieces of component information, and sets a result of the computation as the total work volume. The calculation unit 16 computes a total sum of the work volumes of pieces of component information having the status information indicating “installed” among all the pieces of component information, and sets a result of the computation as the actual work volume. The status information on the component information is initially set to the information indicating “not installed,” and hence the actual work volume in the preliminary calculation is set to zero.

Subsequently, the calculation unit 16 extracts the planned schedule information and the forecast schedule information from the IWP information. When effective information is not set in the planned schedule information, the calculation unit 16 does not calculate the planned work volume. Similarly, when effective information is not set in the forecast schedule information, the calculation unit 16 does not calculate the forecast work volume. Meanwhile, when valid information is set in the planned schedule information and the forecast schedule information, the calculation unit 16 compares a date serving as a reference date to a planned finish date and a forecast finish date, and calculates the planned work volume and the forecast work volume based on results of the comparison. The reference date is a date for calculating the work volume, and is determined in advance. The reference date is determined, for example, once a week or once a month. The reference date may be a date on which an application for operating a work package is performed.

Specifically, when the date serving as the reference date is earlier than the planned finish date, the calculation unit 16 sets the planned work volume to zero. Meanwhile, when the date serving as the reference date exceeds the planned finish date, the calculation unit 16 sets the planned work volume to the same work volume as the total work volume. Similarly, when the date serving as the reference date is earlier than the forecast finish date, the calculation unit 16 sets the forecast work volume to zero. Meanwhile, when the date serving as the reference date exceeds the forecast finish date, the calculation unit 16 sets the forecast work volume to the same work volume as the total work volume.

When the date serving as the reference date falls between the planned start date and the planned finish date, the calculation unit 16 may calculate the planned work volume from the total work volume by linear or normal distribution. In this case, when the date serving as the reference date is earlier than the planned start date, the calculation unit 16 sets the planned work volume to zero, and when the date serving as the reference date is later than the planned finish date, sets the planned work volume to the same work volume as the total work volume. The forecast work volume is calculated in the same manner.

Then, the calculation unit 16 outputs the total work volume, the planned work volume, the forecast work volume, and the actual work volume to the update unit 17, and the update unit 17 updates the work volume information on the IWP information to the work volumes received from the calculation unit 16. Similar processing is performed for other IWPs.

Subsequently, the acquisition unit 15 acquires CWP2 information stored in the work package information DB 22. Then, the acquisition unit 15 acquires IWP information on all IWPs forming a CWP2 from the work package information DB 22. Then, the calculation unit 16 computes a total sum of the total work volumes, a total sum of the planned work volumes, a total sum of the forecast work volumes, and a total sum of the actual work volumes of all the pieces of IWP information, and sets results of the calculation as the total work volume, the planned work volume, the forecast work volume, and the actual work volume, respectively, of the CWP2. Then, the calculation unit 16 outputs the total work volume, the planned work volume, the forecast work volume, and the actual work volume to the update unit 17, and the update unit 17 updates the work volume information of the CWP2 information to the work volumes received from the calculation unit 16. Similar processing is performed for other CWP2s.

Subsequently, the acquisition unit 15 acquires CWP1 information stored in the work package information DB 22. Then, the acquisition unit 15 acquires CWP2 information on all CWP2s forming a CWP1 from the work package information DB 22. Then, the calculation unit 16 computes a total sum of the total work volumes, a total sum of the planned work volumes, a total sum of the forecast work volumes, and a total sum of the actual work volumes of all the pieces of CWP2 information, and sets results of the calculation as the total work volume, the planned work volume, the forecast work volume, and the actual work volume, respectively, of the CWP1. Then, the calculation unit 16 outputs the total work volume, the planned work volume, the forecast work volume, and the actual work volume to the update unit 17, and the update unit 17 updates the work volume information of the CWP1 information to the work volumes received from the calculation unit 16. Similar processing is performed for other CWP1s.

Next, the series of procedures of the project management method is described. First, a worker uses the image pickup apparatus 107 to photograph a construction site (installation object). Then, the acquisition unit 11 acquires an on-site image obtained through photographing by the worker through use of the image pickup apparatus 107 (Step S11). Then, the acquisition unit 11 outputs the on-site image to the display control unit 13.

Subsequently, the acquisition unit 12 acquires engineering model data on components to be installed in a region of a real space included in the on-site image (Step S12). To describe specifically, the acquisition unit 12 acquires position information on the project management apparatus 10 from a GPS receiver built into the project management apparatus 10, and acquires posture information on the project management apparatus from a gyroscope built into the project management apparatus

Then, the acquisition unit 12 calculates the region of the real space included in the on-site image based on the position information and the posture information. A method of calculating a region of a real space included in an on-site image is publicly known, and hence a detailed description is omitted herein. When markers are provided at the same positions in the real space and the engineering model data, the acquisition unit 12 may calculate the region of the real space included in the on-site image through position alignment between the markers provided in the real space and the markers provided in the engineering model data.

Then, the acquisition unit 12 acquires, from among the pieces of engineering model information stored in the model information DB 21, pieces of engineering model information on the components positioned in a region included in the on-site image. The acquisition unit 12 acquires, from among the pieces of component information stored in the component information DB 23, pieces of component information on the components positioned in a region included in the on-site image. Then, the acquisition unit 12 outputs the engineering model information and the component information to the display control unit 13.

Subsequently, when the display control unit 13 receives the on-site image from the acquisition unit 11 and receives the engineering model data and the component information from the acquisition unit 12, the display control unit 13 generates a composite image by superimposing the engineering model data on the on-site image, and displays the composite image on the display apparatus (Step S13). A method of generating a composite image is publicly known, and hence a detailed description is omitted herein. At this time, the display control unit 13 classifies, based on the status information of the component information, the components into “installed” components and “not installed” components.

When a valid date is registered as the work finish date of a piece of component information, the display control unit 13 may determine that the component corresponding to this piece of component information has been installed, and when no valid date is registered as the work finish date of the component information, determine that the component corresponding to this piece of component information has not been installed. Then, the display control unit 13 displays, on the display apparatus, the engineering model data on each “installed” component and the engineering model data on each “not installed” component in a manner distinguishable from each other.

For example, the display control unit 13 displays the engineering model data on each “installed” component and the engineering model data on each “not installed” component in colors different from each other. The display control unit 13 may control the display apparatus so as not to display the engineering model data on any “installed” component. The display control unit 13 may display, on the display apparatus, components so as to enable the worker to set transparency of the engineering model data for each of the components.

In the example illustrated in FIG. 7, pieces of engineering model data on a component C1 indicated by a component ID of “A110-AI-63-40010,” a component C2 indicated by a component ID of “A110-AI-63-40020,” a component C3 indicated by a component ID of “A110-AI-63-40030,” and a component C4 indicated by a component ID of “A110-AI-63-40040” are displayed. The components C1 and C4 are “not installed” components, and hence the pieces of engineering model data are displayed at positions at which the components C1 and C4 are planned to be installed. The components C2 and C3 are “installed” components, but the pieces of engineering model data are displayed by being superimposed on the components in the on-site image. Other components have been installed, and no engineering model data is displayed therefor.

Subsequently, the reception unit 14 determines whether or not the worker has performed an operation (Step S14). When it is determined that the worker has not performed any operation (NO in Step S14), the series of procedures of the project management method is finished. Meanwhile, when it is determined that the worker has performed an operation (YES in Step S14), the reception unit 14 outputs the operation information indicating the details of the operation to the display control unit 13, the acquisition unit 15, the calculation unit 16, and the update unit 17.

Subsequently, processing corresponding to the operation of the worker is performed (Step S15). An example of the processing corresponding to the operation of the worker is described below.

For example, as illustrated in FIG. 8, when the worker selects a component (engineering model data) on the display screen illustrated in FIG. 7, the display control unit 13 controls the display apparatus to display icons Ie, Ip, and Ic so that the icons Ie, Ip, and Ic are superimposed on the composite image. The icon Ie is an icon for displaying information relating to the engineering of the selected component. The icon Ip is an icon for displaying information relating to the procurement of the selected component. The icon Ic is an icon for displaying the information relating to the construction of the selected component. A component is selected by, for example, the worker tapping a piece of engineering model data on the component.

When the worker selects (taps) the icon Ie on the display screen illustrated in FIG. 8, the acquisition unit 15 acquires a piece of drawing information containing the component ID of the selected component from the pieces of drawing information stored in the drawing information DB 24. Then, the acquisition unit 15 outputs the piece of drawing information to the display control unit 13. Then, when the display control unit 13 receives the piece of drawing information from the acquisition unit 15, the display control unit 13 displays, on the display apparatus, the engineering drawing data contained in the piece of drawing information. When a plurality of pieces of drawing information contain the component ID of the selected component, the display control unit 13 may display a list of the pieces of engineering drawing data on the display apparatus. When the drawing information contains the information indicating the issue status of the drawing, the display control unit 13 may display, on the display apparatus, the issue status of the drawing together with the engineering drawing data.

When the worker selects (taps) the icon Ip on the display screen illustrated in FIG. 8, the acquisition unit 15 acquires a piece of procurement information containing the component ID of the selected component from the pieces of procurement information stored in the procurement information DB 25. Then, the acquisition unit 15 outputs the piece of procurement information to the display control unit 13. Then, when the display control unit 13 receives the piece of procurement information from the acquisition unit 15, the display control unit 13 displays the piece of procurement information on the display apparatus.

When the worker selects (taps) the icon Ic on the display screen illustrated in FIG. 8, as illustrated in FIG. 9, the display control unit 13 displays a button Bp and a button Bs on the display apparatus. The button Bp is a button for displaying the property information on the selected component. The button Bs is a button for inputting the progress state of the construction work of the selected component.

When the worker selects (taps) the button Bp on the display screen illustrated in FIG. 9, the acquisition unit 15 acquires, from among the pieces of work package information stored in the work package information DB 22, a piece of IWP information containing the component ID of the selected component, a piece of CWP2 information containing the work package ID contained in this piece of IWP information, and a piece of CWP1 information containing the work package ID contained in this piece of CWP2 information. The acquisition unit 15 acquires, from among the pieces of component information stored in the component information DB 23, a piece of component information containing the component ID of the selected component. Then, the acquisition unit 15 outputs the piece of IWP information, the piece of CWP2 information, the piece of CWP1 information, and the piece of component information to display control unit 13. Then, when the display control unit 13 receives the piece of IWP information, the piece of CWP2 information, the piece of CWP1 information, and the piece of component information from the acquisition unit 15, as illustrated in FIG. 10, the display control unit 13 displays the property information on the selected component on the display apparatus.

On the display screen illustrated in FIG. 10, the component information on the selected component, the work package IDs of the IWP, the CWP2, and the CWP1 containing the work of this component, and the details of the construction work (construction work outline description) of the IWP are displayed as the property information. In addition, a button Bcwp1, a button Bcwp2, and a button Biwp are displayed on the display screen illustrated in FIG. 10. The button Bcwp1 is a button for examining detailed information relating to a CWP1. The button Bcwp2 is a button for examining detailed information relating to a CWP2. The button Biwp is a button for examining detailed information relating to an IWP.

When the worker selects (taps) the button Biwp on the display screen illustrated in FIG. 10, the acquisition unit 15 acquires, for all the component IDs contained in the IWP information, pieces of component information containing the respective component IDs from among the pieces of component information stored in the component information DB 23. Then, the acquisition unit 15 outputs the acquired pieces of component information to the display control unit 13. Then, when the display control unit 13 receives the pieces of component information from the acquisition unit 15, as illustrated in FIG. 11, the display control unit 13 displays detailed information relating to the IWP on the display apparatus.

The display screen illustrated in FIG. 11 includes regions Ri1 to Ri5. The region Ri1 is a region for displaying a basic property of the IWP. As the basic property, for example, the work package ID of the IWP, the details of the construction work (construction work outline description) of the IWP, and the work package IDs of the CWP1 and CWP2 containing the IWP are displayed. The region Ri2 is a region for displaying the schedule of the IWP. When valid information is contained in the planned start date, the planned finish date, the forecast start date, the forecast finish date, the work start date, and the work finish date of the IWP information, those dates are displayed. When no valid information is contained in the planned start date, the planned finish date, the forecast start date, the forecast finish date, the work start date, and the work finish date of the IWP information, the region Ri2 is left blank. Each date is displayed in a manner that enables the worker to input and change the date.

The region Ri3 is a region for displaying the work volume of the IWP. As the work volume, the total work volume, the planned work volume, the forecast work volume, and the actual work volume are displayed. In addition, progress rates are displayed for the planned work volume, the forecast work volume, and the actual work volume. The progress rates are each calculated as a ratio (%) of each work volume to the total work volume. The region Ri4 is a region for displaying the progress state of the IWP. On the display screen of FIG. 11, all possible progress states of the IWP are displayed in a list, and the progress state indicated by the status information of the IWP information is marked. The progress status of the IWP is set to “not started” when all the components forming the IWP are “not installed,” is set to “completed” when all the components are “installed,” and is set to “started” when some of the components are “not installed” and the rest are “installed.”

The region Ri5 is a region for displaying all the components forming the IWP. On the display screen of FIG. 11, the component IDs, the progress states of the construction work, and the work volumes are displayed for all the components in a list. The work finish date is further displayed for the “installed” component. Each component (component ID) is displayed in a manner that enables the worker to select the component. When the worker selects (taps) the component in the region Ri5, the display screen illustrated in FIG. 9 is displayed. That is, the same processing is performed as in a case in which the worker has selected the component (the engineering model data) in the composite image illustrated in FIG. 7 and has selected the icon Ic on the display screen illustrated in FIG. 8.

On the display screen illustrated in FIG. 11, the date serving as the reference date is further displayed.

When the worker selects (taps) the button Bcwp2 on the display screen illustrated in FIG. 10, the acquisition unit 15 acquires, for the work package IDs of all the IWPs contained in the CWP2 information, pieces of IWP information containing the respective work package IDs from the pieces of work package information stored in the work package information DB 22. Then, the acquisition unit 15 outputs the acquired pieces of IWP information to the display control unit 13. Then, when the display control unit 13 receives the pieces of IWP information from the acquisition unit 15, as illustrated in FIG. 12, the display control unit 13 displays detailed information relating to the CWP2 on the display apparatus.

The display screen illustrated in FIG. 12 includes regions Rc21 to Rc25. The region Rc21 is a region for displaying a basic property of the CWP2. As the basic property, for example, the work package IDs of the CWP1 and the CWP2 are displayed. The region Rc22 is a region for displaying the schedule of the CWP2. When valid information is contained in the planned start date, the planned finish date, the forecast start date, the forecast finish date, the work start date, and the work finish date of the CWP2 information, those dates are displayed. When no valid information is contained in the planned start date, the planned finish date, the forecast start date, the forecast finish date, the work start date, and the work finish date of the CWP2 information, the region Rc22 is left blank.

The planned start date is set to the earliest date among the planned start dates of all the IWPs forming the CWP2. The planned finish date is set to the latest date among the planned finish dates of all the IWPs forming the CWP2. The forecast start date is set to the earliest date among the forecast start dates of all the IWPs forming the CWP2. The forecast finish date is set to the latest date among the forecast finish dates of all the IWPs forming the CWP2. The work start date is set to the earliest date among the work start dates of all the IWPs forming the CWP2. The work finish date is set to the latest date among the work finish dates of all the IWPs forming the CWP2.

The region Rc23 is a region for displaying the work volume of the CWP2. As the work volume, the total work volume, the planned work volume, the forecast work volume, and the actual work volume are displayed. In addition, progress rates are displayed for the planned work volume, the forecast work volume, and the actual work volume. The region Rc24 is a region for displaying the progress state of the CWP2. On the display screen of FIG. 12, all possible progress states of the CWP2 are displayed in a list, and the progress state indicated by the status information of the CWP2 information is marked. The progress status of the CWP2 is set to “not started” when all the IWPs forming the CWP2 are “not started,” is set to “completed” when all the IWPs are “completed,” and is set to “started” when some of the IWPs are “not started” and the rest are “completed.”

The region Rc25 is a region for displaying all the IWPs forming the CWP2. On the display screen of FIG. 12, the work package IDs, the progress states, dates on which the current progress states are achieved, and the work volumes are displayed for all the IWPs in a list. Each IWP (work package ID) is displayed in a manner that enables the worker to select the IWP. When the worker selects (taps) the IWP in the region Rc25, the display screen illustrated in FIG. 11 is displayed.

On the display screen illustrated in FIG. 12, the date serving as the reference date is further displayed.

When the worker selects (taps) the button Bcwp1 on the display screen illustrated in FIG. 10, the acquisition unit 15 acquires, for the work package IDs of all the CWP2s contained in the CWP1 information, pieces of CWP2 information containing the respective work package IDs from the pieces of work package information stored in the work package information DB 22. Then, the acquisition unit 15 outputs the acquired pieces of CWP2 information to the display control unit 13. Then, when the display control unit 13 receives the pieces of CWP2 information from the acquisition unit 15, as illustrated in FIG. 13, the display control unit 13 displays detailed information relating to the CWP1 on the display apparatus.

The display screen illustrated in FIG. 13 includes regions Rc11 to Rc15. The region Rc11 is a region for displaying a basic property of the CWP1. As the basic property, for example, the work package ID of the CWP1 is displayed. The region Rc12 is a region for displaying the schedule of the CWP1. When valid information is contained in the planned start date, the planned finish date, the forecast start date, the forecast finish date, the work start date, and the work finish date of the CWP1 information, those dates are displayed. When no valid information is contained in the planned start date, the planned finish date, the forecast start date, the forecast finish date, the work start date, and the work finish date of the CWP1 information, the region Rc12 is left blank.

The planned start date is set to the earliest date among the planned start dates of all the CWP2s forming the CWP1. The planned finish date is set to the latest date among the planned finish dates of all the CWP2s forming the CWP1. The forecast start date is set to the earliest date among the forecast start dates of all the CWP2s forming the CWP1. The forecast finish date is set to the latest date among the forecast finish dates of all the CWP2s forming the CWP1. The work start date is set to the earliest date among the work start dates of all the CWP2s forming the CWP1. The work finish date is set to the latest date among the work finish dates of all the CWP2s forming the CWP1.

The region Rc13 is a region for displaying the work volume of the CWP1. As the work volume, the total work volume, the planned work volume, the forecast work volume, and the actual work volume are displayed. In addition, progress rates are displayed for the planned work volume, the forecast work volume, and the actual work volume. The region Rc14 is a region for displaying the progress state of the CWP1. On the display screen of FIG. 13, all possible progress states of the CWP1 are displayed in a list, and the progress state indicated by the status information of the CWP1 information is marked. The progress status of the CWP1 is set to “not started” when all the CWP2s forming the CWP1 are “not started,” is set to “completed” when all the CWP2s are “completed,” and is set to “started” when some of the CWP2s are “not started” and the rest are “completed.”

The region Rc15 is a region for displaying all the CWP2s forming the CWP1. On the display screen of FIG. 13, the work package IDs, the progress states, dates on which the current progress states are achieved, and the work volumes are displayed for all the CWP2s in a list. Each CWP2 (work package ID) is displayed in a manner that enables the worker to select the CWP2. When the worker selects (taps) the CWP2s in the region Rc15, the display screen illustrated in FIG. 12 is displayed.

On the display screen illustrated in FIG. 13, the date serving as the reference date is further displayed.

When the worker selects (taps) the button Bs on the display screen illustrated in FIG. 9, as illustrated in FIG. 14, the display control unit 13 displays, on the display apparatus, a screen for inputting the progress state of the construction work of the selected component. On the display screen illustrated in FIG. 14, a button Bs1, a button Bs2, and a button Ba are displayed. The button Bs1 is a button for setting the progress state of the selected component to “not installed.” The button Bs2 is a button for setting the progress state of the selected component to “installed.” The button Ba is a button for adding a new state as the progress state of the component in addition to “not installed” and “installed.” The worker can set the progress state of the selected component by selecting (tapping) the button Bs1 or the button Bs2.

When the worker performs, on the display screen illustrated in FIG. 7, an operation for displaying information (visualization information) that visualizes information relating to the project, as illustrated in FIG. 15, icons Isc, Ipr, and Igr are displayed by being superimposed on the composite image. The icon Isc is an icon for visualizing and displaying the schedule of the project. The icon Ipr is an icon for visualizing and displaying the progress of the project. The icon Igr is an icon for visualizing and displaying various kinds of statistical information on the project. The operation for displaying the visualization information is performed by, for example, the worker performing a double tap on the display screen illustrated in FIG. 7.

When the worker selects (taps) any one of the icons Isc, Ipr, or Igr on the display screen illustrated in FIG. 15, the display control unit 13 displays, on the display apparatus, a screen for setting the granularity of the visualization information. For example, as illustrated in FIG. 16, a button B1 to a button B3 are displayed. The button B1 is a button for displaying the visualization information on the CWP1. The button B2 is a button for displaying the visualization information on the CWP2. The button B3 is a button for displaying the visualization information on the IWP.

When the worker selects (taps) the icon Isc on the display screen illustrated in FIG. 15 and selects (taps) the button B1 on the display screen illustrated in FIG. 16, the acquisition unit 15 acquires all the pieces of CWP1 information stored in the work package information DB 22. Then, the acquisition unit 15 outputs the pieces of CWP1 information to the display control unit 13. Then, when the display control unit 13 receives the pieces of CWP1 information from the acquisition unit 15, as illustrated in FIG. 17, the display control unit 13 displays, on the display apparatus, the planned schedule information, the forecast schedule information, and the actual schedule information contained in the CWP1 information for each CWP1.

On the display screen illustrated in FIG. 17, the planned schedule, the forecast schedule, and the actual schedule of each CWP1 are displayed in bar charts. A date on which a schedule display operation is performed is indicated by a broken line Lc. A display format of the schedules is not limited to the bar charts, and any format can be employed therefor. For example, the schedule may be displayed in a table format.

When the worker selects (taps) the icon Ipr on the display screen illustrated in FIG. 15 and selects (taps) the button B1 on the display screen illustrated in FIG. 16, the acquisition unit 15 acquires all the pieces of CWP1 information stored in the work package information DB 22. Then, the acquisition unit 15 outputs the pieces of CWP1 information to the display control unit 13. Then, when the display control unit 13 receives the pieces of CWP1 information from the acquisition unit 15, as illustrated in FIG. 18, the display control unit 13 displays, on the display apparatus, the planned work volume, the forecast work volume, and the actual work volume for each CWP1 based on the work volume information contained in the CWP1 information.

On the display screen illustrated in FIG. 18, the planned work volume, the forecast work volume, and the actual work volume of each CWP1 are displayed in terms of progress rate. A weight factor is assigned to each CWP1. The weight factor is set to be proportional to, for example, a work time (MH) required for the work of the CWP1. The weight factor may be set to be proportional to a total cost required for the work of the CWP1. The respective weight factors are set so that a total sum of the weight factors assigned to all the CWP1s is 1 (100%). The progress rate of the entire project is obtained by computing a total sum of values each obtained by multiplying the progress rate and the weight factor of each CWP1. A display format of the work volumes is not limited to the table format, and any format can be employed therefor.

When the worker selects (taps) the icon Igr on the display screen illustrated in FIG. 15 and selects (taps) the button B1 on the display screen illustrated in FIG. 16, the acquisition unit 15 acquires all the pieces of CWP1 information stored in the work package information DB 22. Then, the acquisition unit 15 outputs the pieces of CWP1 information to the display control unit 13. Then, when the display control unit 13 receives the pieces of CWP1 information from the acquisition unit 15, for example, the display control unit 13 displays, on the display apparatus, changes over time in the progress rates of the planned work volume, the forecast work volume, and the actual work volume based on the work volume information contained in the CWP1 information. As a display format of changes over time in the progress rates, any format can be employed therefor.

When the worker performs an operation for examining arrangement of construction equipment on the display screen illustrated in FIG. 7, as illustrated in FIG. 19, the display control unit 13 controls the display apparatus to display an icon Ieq so that the icon Ieq is superimposed on the composite image. The icon Ieq is an icon for arranging the construction equipment model data on the composite image. The operation for examining the arrangement of construction equipment is performed by, for example, the worker performing a long press on the display screen illustrated in FIG. 7.

When the worker selects (taps) the icon Ieq on the display screen illustrated in FIG. 19, the display control unit 13 displays, on the display apparatus, a list of the pieces of construction equipment model information stored in the model information DB 21. Then, when the worker selects a piece of construction equipment model information from the list, the acquisition unit 15 acquires the selected piece of construction equipment model information from among the pieces of construction equipment model information stored in the model information DB 21. Then, the acquisition unit 15 outputs the piece of construction equipment model information to the display control unit 13. Then, when the display control unit 13 receives the piece of construction equipment model information from the acquisition unit 15, the display control unit 13 controls the display apparatus to display the construction equipment model data contained in the piece of construction equipment model information so that the construction equipment model data is superimposed on the composite image. Then, the worker examines a space and the like required for the work while changing a position and an orientation of the construction equipment model data.

Referring back to FIG. 6, a continuation of the series of procedures of the project management method is described. Subsequently to Step S15, the calculation unit 16 determines whether or not any information has been changed by the worker (Step S16). When it is determined that no information has been changed (NO in Step S16), the series of procedures of the project management method is finished. Meanwhile, when it is determined that any information has been changed (YES in Step S16), the calculation unit 16 determines whether or not processing that can change a work volume has been performed (Step S17).

When it is determined that no processing that can change a work volume has been performed (NO in Step S17), the update unit 17 updates the information stored in the server apparatus 20 to the changed information (Step S19). As a result, the series of procedures of the project management method is finished.

Meanwhile, when it is determined that processing that can change a work volume has been performed (YES in Step S17), the calculation unit 16 calculates the work volume (Step S18), and outputs the changed work volume to the update unit 17. Subsequently, when the update unit 17 receives the changed work volume from the calculation unit 16, the update unit 17 updates the information stored in the server apparatus 20 to the information changed by the worker, and updates the work volume information of a piece of work package information corresponding to the changed work volume among the pieces of work package information stored in the work package information DB 22 (Step S19). As a result, the series of procedures of the project management method is finished.

Now, some specific examples are used to describe processing to be performed when processing that can change a work volume has been performed. For example, when the status information on a component has been changed, the calculation unit 16 determines that processing that can change a work volume has been performed (YES in Step S17). Specifically, when the worker selects (taps) the button Bs2 on the display screen illustrated in FIG. 14, the calculation unit 16 determines that processing that can change a work volume has been performed (YES in Step S17).

Then, the calculation unit 16 causes the acquisition unit 15 to acquire, from the work package information DB 22, a piece of IWP information containing this component as a constituent thereof. Then, the calculation unit 16 adds the work volume of this component to the actual work volume contained in the piece of IWP information, and sets a result of the addition as the changed actual work volume of the IWP (Step S18). In addition, the calculation unit 16 causes the acquisition unit 15 to acquire, from the work package information DB 22, pieces of IWP information on all the IWPs contained in a CWP2 containing those IWPs as constituents thereof. Then, the calculation unit 16 computes a total sum of the actual work volumes of all the IWPs, and sets a result of the computation as the changed actual work volume of the CWP2 (Step S18). Similarly, the calculation unit 16 causes the acquisition unit 15 to acquire, from the work package information DB 22, pieces of CWP2 information on all the CWP2s contained in a CWP1 containing those CWP2s as constituents thereof. Then, the calculation unit 16 computes a total sum of the actual work volumes of all the CWP2s, and sets a result of the computation as the changed actual work volume of the CWP1 (Step S18). Then, the calculation unit 16 outputs the actual work volumes of the respective work packages to the update unit 17.

Then, the update unit 17 sets the status information on the selected component to the information indicating “installed.” At this time, the update unit 17 sets the work finish date of the selected component to a date (current date) on which the button Bs2 is selected. When the button Bs2 is selected, a box or the like for inputting the work finish date may be further displayed. In this case, the update unit 17 sets the work finish date of the selected component to the date input by the worker. Then, the update unit 17 updates the status information and the work finish date contained in the piece of component information on this component stored in the component information DB 23 (Step S19). In addition, when the update unit 17 receives the actual work volumes from the calculation unit 16, the update unit 17 updates the actual work volumes of the IWP information, the CWP2 information, and the CWP1 information contained in the work package information DB 22 (Step S19).

As another example, the calculation unit 16 determines that the processing that can change a work volume has been performed when, for example, the forecast schedule information on the IWP has been changed (YES in Step S17). Then, as described above, the calculation unit 16 compares the forecast finish date and the date serving as the reference date to each other, and calculates the forecast work volume based on results of the comparison (Step S18). In addition, the calculation unit 16 causes the acquisition unit 15 to acquire, from the work package information DB 22, pieces of IWP information on all the IWPs contained in the CWP2 containing this IWP as a constituent thereof. Then, the calculation unit 16 computes a total sum of the forecast work volumes of all the IWPs, and sets a result of the computation as the changed forecast work volume of the CWP2 (Step S18). Similarly, the calculation unit 16 causes the acquisition unit 15 to acquire, from the work package information DB 22, pieces of CWP2 information on all the CWP2s contained in the CWP1 containing this CWP2 as a constituent thereof. Then, the calculation unit 16 computes a total sum of the forecast work volumes of all the CWP2s, and sets a result of the computation as the changed forecast work volume of the CWP1 (Step S18). Then, the calculation unit 16 outputs the forecast work volumes of the respective work packages to the update unit 17.

Then, the update unit 17 updates the schedule information on the IWP information stored in the work package information DB 22 to the schedule information input by the user (Step S19). In addition, when the update unit 17 receives the forecast work volumes from the calculation unit 16, the update unit 17 updates the forecast work volumes of the IWP information, the CWP2 information, and the CWP1 information contained in the work package information DB 22 (Step S19).

Next, referring to FIG. 20, description is given of the project management program P for causing a computer to function as the project management apparatus 10 and a recording medium MD for recording the project management program P. FIG. 20 is a diagram for illustrating a configuration of the project management program recorded in the recording medium.

As illustrated in FIG. 20, the project management program P includes a main module P10, an acquisition module P11, an acquisition module P12, a display control module P13, a reception module P14, an acquisition module P15, a calculation module P16, and an update module P17. The main module P10 is a part that integrally controls processing relating to the project management. Functions implemented by executing the acquisition module P11, the acquisition module P12, the display control module P13, the reception module P14, the acquisition module P15, the calculation module P16, and the update module P17 are the same as the functions of the acquisition unit 11, the acquisition unit 12, the display control unit 13, the reception unit 14, the acquisition unit 15, the calculation unit 16, and the update unit 17 in the embodiment described above, respectively.

The project management program P is supplied in the computer-readable recording medium MD such as a compact disc-read only memory (CD-ROM), a digital versatile disc-read only memory (DVD-ROM), and a semiconductor memory. The project management program P may be supplied as a data signal through the network NW.

In the project management apparatus 10, the project management method, and the recording medium having recorded thereon the project management program P described above, a composite image generated by superimposing the engineering model data on the on-site image is displayed on the display apparatus. According to this configuration, the user (worker) can visually grasp the progress statuses of the work package and the component from the composite image. Then, when the user selects the engineering model data in the composite image, the display screen for causing the user to input the information relating to the progress of the IWP, the CWP2, and the CWP1 containing the work of the component corresponding to the engineering model data selected by the user is displayed on the display apparatus. Therefore, it is possible to prompt the user to input the information relating to the progress of the IWP, the CWP2, and the CWP1. After visually grasping the progress statuses of the component, the IWP, the CWP2, and the CWP1, the user can input the information relating to the progress of the IWP, the CWP2, and the CWP1 without delay. As a result, it is possible to reduce labor required for inputting information relating to progress.

The display control unit 13 displays, on the display apparatus, the work volumes of the IWP, the CWP2, and the CWP1 based on the operation performed on the composite image by the user. According to this configuration, the user can grasp the work volumes of the IWP, the CWP2, and the CWP1.

When the schedules of work packages (IWP, CWP2, and CWP1) are changed, the work volumes of those work packages can change. For example, when the planned finish date of the IWP is changed to a date earlier than the date serving as the reference date, all the works of this IWP are supposed to have been finished. Meanwhile, the display screen includes the regions (regions Ri2, Rc22, and Rc12) each of which enables the user to input the schedule of the work package. The calculation unit 16 calculates the work volume of the work package based on the schedule input by the user. According to this configuration, when the schedule of a work package is input, the work volume of this work package can be properly updated. Therefore, the user can accurately grasp the work volume of the work package.

When the progress state of a component is changed, the work volume of the work package containing the work of the component can change. For example, when the progress state of the component is changed from “not installed” to “installed,” the work volume of this component is added to the actual work volume of the IWP. Meanwhile, the display screen includes the region (see FIG. 14) which enables the user to input the progress state of the component. The calculation unit 16 calculates the work volume of the work package based on the progress state input by the user. According to this configuration, when the progress state of the component is input, the work volume of the work package can be properly updated. Therefore, the user can accurately grasp the work volume of the work package.

The display control unit 13 displays, on the display apparatus, the engineering drawing data containing the component selected by the user based on the operation performed on the composite image by the user. According to this configuration, the user can examine the engineering drawing on the display apparatus. For example, the worker at the construction site is not required to bring an engineering drawing document to the construction site, and hence it is possible to reduce a load on the worker.

The display control unit 13 displays, on the display apparatus, the procurement information on the component selected by the user based on the operation performed on the composite image by the user. According to this configuration, the user can examine the procurement information on the display apparatus. For example, the worker at the construction site is not required to bring a document relating to the procurement information to the construction site, and hence it is possible to reduce a load on the worker.

The project management apparatus, the project management method, and the recording medium according to this disclosure are not limited to those of the above-mentioned embodiment.

For example, each of the project management apparatus 10 and the server apparatus 20 may be constructed by one apparatus joined physically or logically, or may be constructed by a plurality of apparatus physically or logically separated from one another. For example, each of the project management apparatus 10 and the server apparatus 20 may be implemented by a plurality of computers distributed on a network as in the cloud computing.

The project management apparatus 10 may include at least one of the model information DB 21, the work package information DB 22, the component information DB 23, the drawing information DB 24, or the procurement information DB 25. When the project management apparatus 10 includes databases similar to the model information DB 21, the work package information DB 22, the component information DB 23, the drawing information DB 24, and the procurement information DB 25, the project management apparatus 10 may synchronize those databases with the model information DB 21, the work package information DB 22, the component information DB 23, the drawing information DB 24, and the procurement information DB 25 of the server apparatus 20, respectively.

Each of the engineering model data and the construction equipment model data may be a 2D model.

The project management apparatus 10 is not required to include the image pickup apparatus 107. In this case, the acquisition unit 11 acquires an on-site image from an external image pickup apparatus.

The project management apparatus 10 is not required to include the display apparatus. In this case, the display control unit 13 transmits display information to an external display apparatus, to thereby display predetermined information on the display apparatus.

The configurations of the model information DB 21, the work package information DB 22, the component information DB 23, the drawing information DB 24, and the procurement information DB 25 are not limited to the configurations of the above-mentioned embodiment. The configurations of the respective databases may be modified by a publicly-known method.

### REFERENCE SIGNS LIST

1 project management system, 10 project management apparatus, 11 acquisition unit (first acquisition unit), 12 acquisition unit (second acquisition unit), 13 display control unit, 14 reception unit, 16 calculation unit, 17 update unit, 106 output apparatus (display apparatus), MD recording medium, P project management program

1. A project management apparatus for managing a project of constructing an installation object, the project management apparatus comprising:
a first acquisition unit configured to acquire an on-site image obtained by photographing a construction site in which the installation object is to be constructed;
a second acquisition unit configured to acquire engineering model data on each of a plurality of components forming the installation object;
a display control unit configured to display, on a display apparatus, a composite image obtained by superimposing the engineering model data on the on-site image; and
a reception unit configured to receive an operation of a user,
wherein the display control unit is configured to display, based on the operation performed on the composite image by the user, a display screen for causing the user to input information relating to progress of a first work unit, which is a work unit containing a work of a first component being a component corresponding to the engineering model data selected by the user, on the display apparatus.

2. The project management apparatus according to claim 1, further comprising a calculation unit configured to calculate a work volume of the work unit,
wherein the display control unit is configured to display the work volume on the display apparatus based on the operation performed on the composite image by the user.

3. The project management apparatus according to claim 2,
wherein the display screen includes a region that enables the user to input a schedule of the first work unit, and
wherein the calculation unit is configured to calculate the work volume based on the schedule input by the user.

4. The project management apparatus according to claim 2,
wherein the display screen includes a region that enables the user to input a progress state of the first component, and
wherein the calculation unit is configured to calculate the work volume based on the progress state input by the user.

5. The project management apparatus according to claim 1, wherein the display control unit is configured to display engineering drawing data containing the first component on the display apparatus based on the operation performed on the composite image by the user.

6. The project management apparatus according to claim 1, wherein the display control unit is configured to display procurement information on the first component on the display apparatus based on the operation performed on the composite image by the user.

7. A project management method for managing a project of constructing an installation object, the project management method comprising:
acquiring an on-site image obtained by photographing a construction site in which the installation object is to be constructed;
acquiring engineering model data on each of a plurality of components forming the installation object;
generating a composite image by superimposing the engineering model data on the on-site image and displaying the composite image on a display apparatus; and
displaying, based on an operation performed on the composite image by a user, a display screen for causing the user to input information relating to progress of a first work unit, which is a work unit containing a work of a first component being a component corresponding to the engineering model data selected by the user, on the display apparatus.

8. A computer-readable recording medium having recoded thereon a project management program for causing a computer to operate to manage a project of constructing an installation object, the project management program being a program for causing the computer to execute:
acquiring an on-site image obtained by photographing a construction site in which the installation object is to be constructed;
acquiring engineering model data on each of a plurality of components forming the installation object;
generating a composite image by superimposing the engineering model data on the on-site image and displaying the composite image on a display apparatus; and
displaying, based on an operation performed on the composite image by a user, a display screen for causing the user to input information relating to progress of a first work unit, which is a work unit containing a work of a first component being a component corresponding to the engineering model data selected by the user, on the display apparatus.

9. The project management apparatus according to claim 3,
wherein the display screen includes a region that enables the user to input a progress state of the first component, and
wherein the calculation unit is configured to calculate the work volume based on the progress state input by the user.

10. The project management apparatus according to claim 2, wherein the display control unit is configured to display engineering drawing data containing the first component on the display apparatus based on the operation performed on the composite image by the user.

11. The project management apparatus according to claim 3, wherein the display control unit is configured to display engineering drawing data containing the first component on the display apparatus based on the operation performed on the composite image by the user.

12. The project management apparatus according to claim 4, wherein the display control unit is configured to display engineering drawing data containing the first component on the display apparatus based on the operation performed on the composite image by the user.

13. The project management apparatus according to claim 9, wherein the display control unit is configured to display engineering drawing data containing the first component on the display apparatus based on the operation performed on the composite image by the user.

14. The project management apparatus according to claim 2, wherein the display control unit is configured to display procurement information on the first component on the display apparatus based on the operation performed on the composite image by the user.

15. The project management apparatus according to claim 3, wherein the display control unit is configured to display procurement information on the first component on the display apparatus based on the operation performed on the composite image by the user.

16. The project management apparatus according to claim 4, wherein the display control unit is configured to display procurement information on the first component on the display apparatus based on the operation performed on the composite image by the user.

17. The project management apparatus according to claim 5, wherein the display control unit is configured to display procurement information on the first component on the display apparatus based on the operation performed on the composite image by the user.

18. The project management apparatus according to claim 9, wherein the display control unit is configured to display procurement information on the first component on the display apparatus based on the operation performed on the composite image by the user.

19. The project management apparatus according to claim 10, wherein the display control unit is configured to display procurement information on the first component on the display apparatus based on the operation performed on the composite image by the user.

20. The project management apparatus according to claim 11, wherein the display control unit is configured to display procurement information on the first component on the display apparatus based on the operation performed on the composite image by the user.
